(19) United States
(12) Patent Application Publication
(10) Pub. No.: US 2008/0112346 A1
(43) Pub. Date: May 15, 2008

(54) WIRELESS DEVICE AND METHODS FOR REDUCING PERIODIC SCANS USING MOTION DETECTION

(76) Inventors: Alexander Tolpin, Netanya (IL); Amit Bernstein, Haifa (IL); Ayelet Alon, Haifa (IL)

Correspondence Address: SCHWEGMAN, LUNDBERG & WOESSNER, P.A., P.O. BOX 2938, MINNEAPOLIS, MN, 55402, US

(21) Appl. No.: 11/558,124

(22) Filed: Nov. 9, 2006

(51) Int. Cl. G08C 17/00; H04Q 7/24

(52) U.S. Cl. 370/311; 370/338

(57) ABSTRACT

Embodiments of a wireless device and methods for reducing period scans using motion diction are generally described herein. Other embodiments may be described and claimed. In some embodiments, a wireless device determines whether or not to refrain from performing periodic scanning based on one or more motion indicators determined from measured signal levels received from a currently associated access point. In some embodiments, a wireless device determines whether or not to refrain from performing periodic scanning based on a rate-of-change of received signal strength indicators (RSSIs) of beacon frames received from a currently associated access point.

### TECHNICAL FIELD

Some embodiments of the present invention pertain to wireless communication systems. Some embodiments pertain to wireless local area networks (WLANs) and wireless devices that perform periodic scanning.

### BACKGROUND

Some portable wireless devices that operate in WLANs perform periodic scans to identify nearby access points for use in making hand-off decisions. These periodic scans consume energy and in some situations, periodic scans may be unnecessary. For example, there may not be a need to hand-off to another access point when a wireless device is stationary or is moving toward its currently associated access point. By reducing the number of periodic scans, wireless devices may be able to reduce their energy consumption and extend their battery life.

Thus, there are general needs for wireless devices and methods for reducing periodic scans when operating in WLANs. There are also general needs for network interface circuitry for wireless devices that uses less energy.

### BRIEF DESCRIPTION OF THE DRAWINGS

FIG. 1 illustrates a wireless network in accordance with some embodiments of the present invention;

FIG. 2 is a block diagram of a wireless device in accordance with some embodiments of the present invention; and

FIG. 3 is a flow chart of a procedure for detecting motion and reducing periodic scans in accordance with some embodiments of the present invention.

### DETAILED DESCRIPTION

The following description and the drawings sufficiently illustrate specific embodiments of the invention to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in, or substituted for those of other embodiments. Embodiments of the invention set forth in the claims encompass all available equivalents of those claims. Embodiments of the invention may be referred to herein, individually or collectively, by the term “invention” merely for convenience and without intending to limit the scope of this application to any single invention or inventive concept if more than one is in fact disclosed.

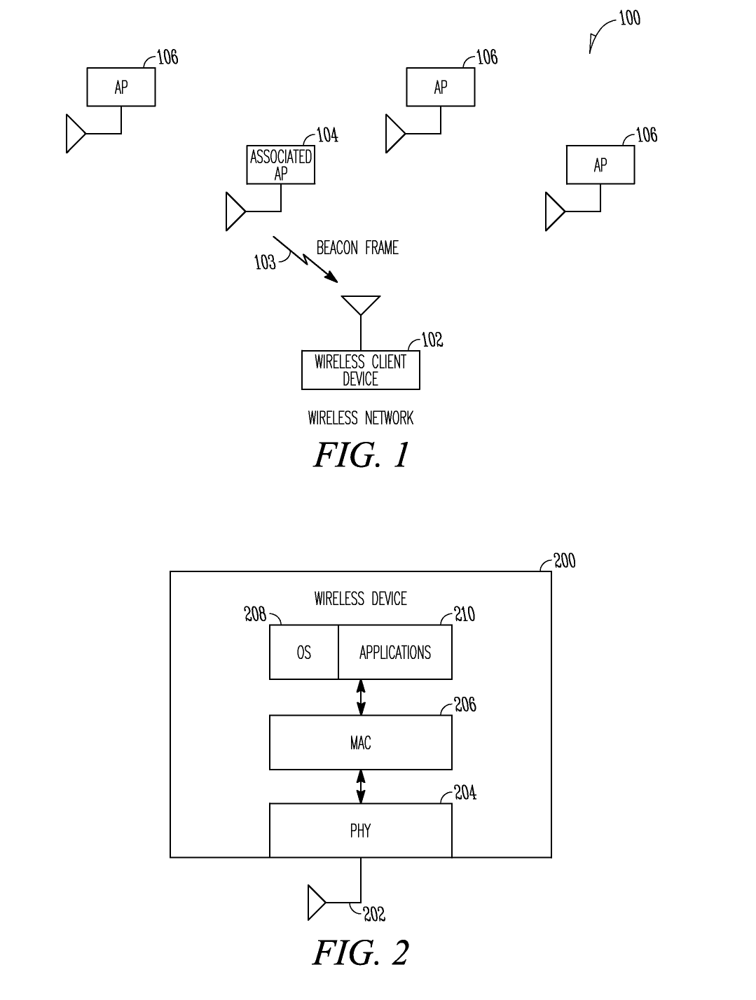

FIG. 1 illustrates a wireless network in accordance with some embodiments of the present invention. Wireless network 100 may include a plurality of access points (APs) including access point 104 and other access points 106. Wireless network 100 may also include one or more wireless devices, such as wireless device 102. Wireless device 102 may be currently associated with access point 104, allowing wireless communications to take place between wireless device 102 and access point 104. Accordingly, wireless device 102 may be able to access other networks, such as the Internet, through access point 104 as well as being able to communicate with other wireless devices.

In some conventional wireless networks, wireless device 102 may perform a periodic scan on a regular basis to identify other access points, such as other access points 106, as well as the channels being used by other access points 106. This information may be used by wireless device 102, for example, to determine when to perform a hand-off to one of other access points 106.

In accordance with some embodiments of the present invention, wireless device 102 determines whether or not to refrain from performing periodic scanning based on measured signal levels received from currently associated access point 104. In some embodiments, wireless device 102 may measure the signal levels of beacon frames 103 received from currently associated access point 104 over a predetermined period of time. In these embodiments, wireless device 102 may refrain from performing periodic scanning when a rate-of-change of the received signal levels indicate little or no movement, or indicate movement in a direction toward currently associated access point 104. Accordingly, unnecessary periodic scanning may be avoided when wireless device 102 is stationary or moving toward currently associated access point 104. In some embodiments, wireless device 102 may determine whether or not to refrain from performing periodic scanning based on a rate-of-change of received signal strength indicators (RSSIs) of beacon frames received from a currently associated access point. These embodiments are discussed in more detail below.

FIG. 2 is a block diagram of a wireless device in accordance with some embodiments of the present invention. Wireless device 200 may be suitable for use as wireless device 102 (FIG. 1) although other configurations may also be suitable. Wireless device 200 may include one or more antennas 202 for transmitting and receiving wireless communication signals with an access point, such as currently associated access point 104 (FIG. 1) and/or one or more other access points, such as other access points 106 (FIG. 1). Wireless device 200 may also include physical (PHY) layer circuitry 204 for generating the wireless communication signals for transmission by antennas 202 and for processing signals received through antennas 202. Wireless device 200 may also include media-access control (MAC) layer circuitry 206 for controlling access to the wireless medium, for providing information for transmission to PHY layer circuitry 204, and for receiving information from PHY layer circuitry 204. Wireless device 200 may also include operation system (OS) 208 and one or more applications 210 that may be running on wireless device 200. Wireless device 200 may also include a system controller and other processing circuitry not separately illustrated. In some embodiments, PHY layer circuitry 204 and MAC layer circuitry 206 may be part of network interface circuitry (NIC) or a network interface card, although the scope of the invention is not limited in this respect.

In accordance with some embodiments of the present invention, physical layer circuitry 204 may measure signal levels received from currently associated access point 104 (FIG. 1) over a predetermined period of time, and MAC layer circuitry 206 may refrain from performing periodic scanning when a rate-of-change of the received signal levels indicates little or no movement, or indicates movement in a direction toward currently associated access point 104 (FIG. 1). Accordingly, unnecessary periodic scanning may be avoided when wireless device 200 is stationary or moving toward currently associated access point 104 (FIG. 1). In some embodiments, wireless device 200 may reduce the number of period scans that are performed based on one or more motion indicators, discussed in more detail below.

In some embodiments, a scan request from operating system 208 may be bypassed. In these embodiments, the scan request may be generated upon the expiration of a scan request timer within wireless device 200. In some alternate embodiments, a portion (e.g., 95%) of the scan cycle may be bypassed when the wireless device is motionless or moving toward the associated access point, although the scope of the invention is not limited in this respect.

In some embodiments, periodic scanning may continue to be performed or may be resumed when the rate-of-change of the received signal levels indicate movement in a direction away from currently associated access point 104 (FIG. 1).

In some embodiments, RSSIs of beacon frames 103 (FIG. 1) regularly transmitted by currently associated access point 104 (FIG. 1) may be determined by MAC layer circuitry 206. In these embodiments, the RSSIs may be accumulated and averaged over the predetermined period of time (i.e., a time slice Tₛ) to generate an average RSSI (Rₐ). A short-term motion indicator (SL₈) may be calculated based on the rate-of-change (i.e., a slope or gradient) of the accumulated number of the average RSSIs (Rₐ). In these embodiments, a long-term motion indicator (SLₐ₈) may also be calculated based on an average of an accumulated number of the short-term motion indicators. Periodic scanning may be refrained when neither the long-term motion indicator nor the short-term motion indicator indicate motion in a direction away from currently associated access point 104 (FIG. 1).

In some embodiments, when the short-term motion indicator is negative and/or less than or equal to a low threshold value (Lₜₕ), the short-term motion indicator may indicate motion of wireless device 200 in a direction away from currently associated access point 104 (FIG. 1). When the short-term motion indicator is positive and/or greater than or equal to a high threshold value (Hₜₕ), the short-term motion indicator may indicate motion in a direction toward currently associated access point 104 (FIG. 1). When the short-term motion indicator has a value between the high and low threshold values, the short-term motion indicator may indicate little or no motion. In these embodiments, when the long-term motion indicator is negative, the long-term motion indicator may indicate motion in a direction away from currently associated access point 104 (FIG. 1).

In some embodiments, the short-term motion indicator may be calculated by inserting the most-recently generated average RSSI (Rₐ) into a first cyclic array that includes the accumulated number of previously generated average RSSIs (e.g., the last several average RSSIs) and calculating an average value (RAₐ) of the array (i.e., the average value of the averaged RSSIs stored in the first cyclic array. In these embodiments, the short-term motion indicator (SL₈) may be calculated based on a gradient using the average value of the first cyclic array and the averaged RSSIs stored in the first cyclic array. In these embodiments, a predetermined number of the short-term motion indicators may be accumulated and the long-term motion indicator (SIₐ₈) may be calculated based on an average of the accumulated predetermined number of short-term motion indicators.

In these embodiments, when an average RSSI is inserted into the first cyclic array, pointers of the first cyclic array are shifted effectively removing the oldest RSSI from the first cyclic array. Accordingly, the first cyclic array operates as a rotating buffer retaining the values of the most recent set of average RSSIs.

In some embodiments, the RSSIs are accumulated for approximately one second and averaged (i.e., for approximately 10 beacon frames). In these embodiments, the short term motion indicator may be calculated every eleven seconds and may be an indicator of motion of wireless device 200 over the last eleven seconds. The long-term motion indicator may be calculated about once every sixty seconds and may be an indicator of motion of wireless device 200 over the last sixty seconds, although the scope of the invention is not limited in this respect.

In some embodiments, the following equation may be used to calculate the short term motion indicator (SL₈).

$$\begin{matrix}{SL}_{8} = 8 \cdot \frac{{\sum }_{i = 0}^{10} ( {x}_{i} - \overline{x} ) ( RA [ i ] - {RA}_{a} )}{{\sum }_{i = 0}^{10} {( {x}_{i} - \overline{x} )}^{2}} \\ = 8 \cdot \frac{\begin{matrix}( - 5 ) ( RA [ 0 ] - {RA}_{a} ) + ( - 4 ) ( RA [ 1 ] - {RA}_{a} ) + \\ ( - 3 ) ( RA [ 2 ] - {RA}_{a} ) + … + ( 5 ) ( RA [ 10 ] - {RA}_{a} )\end{matrix}}{110}\end{matrix}$$

In this equation, RAₐ represents the average value of the first cyclic array, and RA[i] represents the individual averaged RSSIs currently stored in the first cyclic array. The values 8 and 110 are scaling factors that may be used to scale the gradient or slope.

In some embodiments, the RSSI determined from beacon frames may be averaged to determine a rate-of-change of the RSSI. Wireless device 200 may refrain from performing periodic scanning when the rate-of-change indicates little or no movement, or indicates movement in a direction toward currently associated access point 104 (FIG. 1) for at least a predetermined period of time. In some embodiments, a hand-off to one of other access points 106 (FIG. 1) may be initiated when the long-term motion indicator indicates motion away from currently associated access point 104 (FIG. 1), although the scope of the invention is not limited in this respect.

In some embodiments, channels currently being used by one or more of other access points 106 (FIG. 1) may be identified by periodic scanning. Periodic scanning may be used to discover other access points 106 (FIG. 1) and may be performed in response to periodic requests from operating system 208. In some embodiments, the available channels and/or identity of nearby access points 106 (FIG. 1) may be reported at the request of applications 210 operating on wireless device 200, or operating system 208, although the scope of the invention is not limited in this respect.

Although wireless device 200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), and combinations of various hardware and logic circuitry for performing at least the functions described herein. In some embodiments, the functional elements of wireless device 200 may refer to one or more processes operating on one or more processing elements. In some embodiments, wireless device 200 may operate as a wireless client in WLAN 100 (FIG. 1).

Antennas 202 may comprise one or more directional or omnidirectional antennas, including, for example, dipole antennas, monopole antennas, patch antennas, loop antennas, microstrip antennas, or other types of antennas suitable for transmission of RF signals. In some multiple-input, multiple-output (MIMO) embodiments, two or more antennas 202 may be used. In some embodiments, instead of two or more antennas, a single antenna with multiple apertures may be used. In these embodiments, each aperture may be considered a separate antenna. In some embodiments, each antenna may be effectively separated to take advantage of spatial diversity and the different channel characteristics that may result between each of antennas 202 and another wireless communication device.

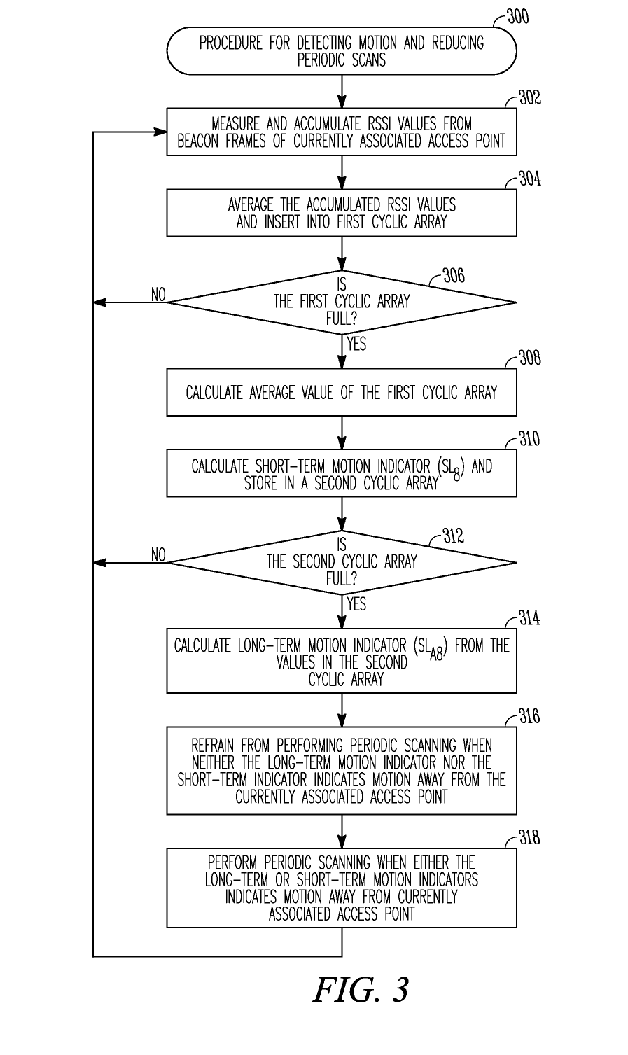

FIG. 3 is a flow chart of a procedure for detecting motion and reducing periodic scans in accordance with some embodiments of the present invention. Procedure 300 may be performed by a wireless device, such as wireless device 102 (FIG. 1), to reduce the number of period scans that are performed based on one or more motion indicators. In some embodiments, procedure 300 may be performed when a wireless device is in an idle state, allowing the wireless device to reduce power consumption during idle state. In other embodiments, procedure 300 may be performed when a wireless device is in a non-idle state, such as an active state.

Operation 302 comprises measuring signal levels and accumulating RSSIs received from the currently associated access point 104 (FIG. 1) over a predetermined period of time. In some embodiments, the RSSIs of beacon frames, such as beacon frames 103 (FIG. 1), may be measured.

Operation 304 comprises averaging the RSSIs that were accumulated over the predetermined period of time (i.e., a time slice Tₛ) to generate an average RSSI (Rₐ). Operation 304 also includes inserting the average RSSI (Rₐ) into the first cyclic array. As operation 304 is being performed a number of times, the first cyclic array may include an accumulated number of previously generated average RSSIs.

Operation 306 comprises determining when the first cyclic array is full (i.e., when the first cyclic array has a predetermined number of average RSSIs.) When the first cyclic array is full, operation 308 is performed. When the first cyclic array is not full, operations 302 through 304 may be repeated until the first cyclic array is full.

Operation 308 comprises calculating an average value of the first cyclic array. The average value of the first cyclic array represents an average value of the averaged RSSIs stored in the first cyclic array. In some embodiments, the average value of the first cyclic array may be represented as RAₐ.

Operation 310 comprises calculating a short-term motion indicator (SL₈) based on the rate-of-change of an accumulated number of the average RSSIs (Ra). In some embodiments, the short-term motion indicator (SL₈) may be calculated based on a gradient using the average value of the first cyclic array and the averaged RSSIs stored in the first cyclic array. In some embodiments, operation 310 may calculate the short-term motion indicator based on the equation for SL₈ previously discussed. Operation 310 may also include storing the short-term motion indicator in a second cyclic array.

Operation 312 comprises determining if the second cyclic array is full. When the second cyclic array is full, operations 314 may be performed. When the second cyclic array is not full, operations 302 through 310 may be repeated until the second cyclic array is full. In some embodiments, the second cyclic array may be full when a predetermined number (e.g., sixty) of short-term motion indicators are accumulated. In other embodiments, the second cyclic array may be full when short term motion indicators are accumulated for a predetermined period of time (e.g., sixty seconds).

Operation 314 comprises calculating the long-term motion indicator (SLₐ₈) based on an average of the number of the short-term motion indicators accumulated in operation 310. In some embodiments, the long-term motion indicator may be the average value of the second cyclic array.

Operation 316 comprises refraining from performing periodic scanning when neither the long-term nor the short-term motion indicators indicate motion away from the currently associated access point. In these embodiments, wireless device 102 (FIG. 1) may refrain from performing periodic scanning when a rate-of-change of the received signal levels either indicate little or no movement or indicate movement in a direction toward currently associated access point 104 (FIG. 1).

Operation 318 comprises performing periodic scanning when either the long-term or the short-term motion indicator indicates motion away from currently associated access point 104 (FIG. 1). In these embodiments, wireless device 102 (FIG. 1) may resume periodic scanning at any time when the rate-of-change of the received signal levels indicates movement in a direction away from currently associated access point 104 (FIG. 1). In some embodiments, periodic scanning may be performed any time when the short-term motion indicator indicates motion away from currently associated access point 104 (FIG. 1).

Although the individual operations of procedure 300 are illustrated and described as separate operations, one or more of the individual operations may be performed concurrently, and nothing requires that the operations be performed in the order illustrated.

Referring to FIG. 1, in some embodiments, wireless device 102 may communicate orthogonal frequency division multiplexed (OFDM) communication signals over a multicarrier communication channel. The multicarrier communication channel may be within a predetermined frequency spectrum and may comprise a plurality of orthogonal subcarriers. In some embodiments, the multicarrier signals may be defined by closely spaced OFDM subcarriers. In some embodiments, wireless device 102 may communicate using spread-spectrum signals, although the scope of the invention is not limited in this respect. In some of these embodiments, wireless network 100 may be a wireless local area network (WLAN) network, such as a Wireless Fidelity (WiFi) network.

In some embodiments, wireless device 102 may be a portable wireless communication device, such as a personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some embodiments, the frequency spectrums for the communication signals communicated by wireless device 102 may comprise either a 5 gigahertz (GHz) frequency spectrum or a 2.4 GHz frequency spectrum. In these embodiments, the 5 gigahertz (GHz) frequency spectrum may include frequencies ranging from approximately 4.9 to 5.9 GHz, and the 2.4 GHz spectrum may include frequencies ranging from approximately 2.3 to 2.5 GHz, although the scope of the invention is not limited in this respect, as other frequency spectrums are also equally suitable. In some embodiments, wireless device 102 may communicate signals in accordance with specific communication standards, such as the Institute of Electrical and Electronics Engineers (IEEE) standards including IEEE 802.11(a), 802.11(b), 802.11(g), 802.11(h) and/or 802.11 (n) standards and/or proposed specifications for wireless local area networks, although the scope of the invention is not limited in this respect as they may also be suitable to transmit and/or receive communications in accordance with other techniques and standards. For more information with respect to the IEEE 802.11 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999” and related amendments/versions. Some embodiments relate to the IEEE 802.11e proposed enhancement to the IEEE 802.11 WLAN specification that will include quality of service (QoS) features, including the prioritization of data, voice, and video transmissions.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, a computing device includes one or more processing elements coupled with computer-readable memory that may be volatile or non-volatile memory or a combination thereof.

Embodiments of the invention may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37° C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus, the following claims are hereby incorporated into the detailed description, with each claim standing on its own as a separate preferred embodiment.

What is claimed is:

1. A method comprising determining whether or not to refrain from performing periodic scanning to identify other access points based on measured signal levels received from a currently associated access point.

2. The method of claim 1 further comprising:
measuring signal levels received from the currently associated access point over a predetermined period of time; and
refraining from performing periodic scanning when a rate-of-change of the received signal levels indicate little or no movement, or indicate movement in a direction toward the currently associated access point.

3. The method of claim 2 wherein refraining comprises bypassing a scan request from an operating system, and
wherein the scan request is generated upon an expiration of a scan request timer.

4. The method of claim 2 further comprising performing periodic scanning when the rate-of-change of the received signal levels indicates movement in a direction away from the currently associated access point.

5. The method of claim 2 wherein measuring signal levels comprises determining received signal strength indicators (RSSIs) of beacon frames regularly transmitted by the currently associated access point.

6. The method of claim 5 further comprising:
accumulating and averaging the RSSIs over the predetermined period of time to generate an average RSSI;
calculating a short-term motion indicator based on the rate-of-change of an accumulated number of the average RSSIs; and
calculating a long-term motion indicator based on an average of an accumulated number of the short-term motion indicators,
wherein periodic scanning is refrained when neither the long-term motion indicator nor the short-term motion indicator indicate motion in a direction away from the currently associated access point.

7. The method of claim 6 wherein when the short-term motion indicator is less than or equal to a low threshold value, the short-term motion indicator indicates motion in a direction away from the currently associated access point,
wherein when the short-term motion indicator is greater than or equal to a high threshold value, the short-term motion indicator indicates motion in a direction toward the currently associated access point,
wherein when the short-term motion indicator has a value between the high and low threshold values, the short-term motion indicator indicates little or no motion, and
wherein when the long-term motion indicator is negative, the long-term motion indicator indicates motion in a direction away from the currently associated access point.

8. The method of claim 6 wherein calculating the short-term motion indicator comprises:
inserting the average RSSI into a first cyclic array that includes the accumulated number of previously generated average RSSIs; and
calculating an average value stored in the first cyclic array,
wherein the short-term motion indicator is calculated based on a gradient using the average value of the first cyclic array and the averaged RSSIs stored in the first cyclic array, and
wherein a predetermined number of the short-term motion indicators are accumulated and the long-term motion indicator is calculated based on an average of the accumulated predetermined number of the short-term motion indicators.

9. The method of claim 1 further comprising:
averaging a received signal strength indicator (RSSI) determined from beacon frames to determine a rate-of-change of the RSSI; and
refraining from performing periodic scanning when the rate-of-change indicates little or no movement, or indicates movement in a direction toward the currently associated access point for at least a predetermined period of time.

10. The method of claim 9 wherein the periodic scanning comprises identifying channels currently being used by the other access points.

11. Network interface circuitry (NIC) comprising:
a physical layer circuitry to measure signal levels received from a currently associated access point over a predetermined period of time; and
a media-access control layer circuitry to refrain from performing periodic scanning when a rate-of-change of the received signal levels indicates little or no movement, or indicates movement in a direction toward the currently associated access point.

12. The network interface circuitry of claim 11 wherein the physical layer circuitry determines received signal strength indicators (RSSIs) of beacon frames regularly transmitted by the currently associated access point.

13. The network interface circuitry of claim 12 wherein the media-access control layer circuitry accumulates and averages the RSSIs over the predetermined period of time to generate an average RSSI, calculates a short-term motion indicator based on a rate-of-change of an accumulated number of the average RSSIs, and calculates a long-term motion indicator based on an average of an accumulated number of the short-term motion indicators, and
wherein the media-access control layer circuitry refrains from periodic scanning when neither the long-term motion indicator nor the short-term motion indicator indicate motion in a direction away from the currently associated access point.

14. The network interface circuitry of claim 13 wherein when the short-term motion indicator is less than or equal to a low threshold value, the short-term motion indicator indicates motion in a direction away from the currently associated access point,
wherein when the short-term motion indicator is greater than or equal to a high threshold value, the short-term motion indicator indicates motion in a direction toward the currently associated access point,
wherein when the short-term motion indicator has a value between the high and low threshold values, the short-term motion indicator indicates little or no motion, and
wherein when the long-term motion indicator is negative, the long-term motion indicator indicates motion in a direction away from the currently associated access point.

15. The network interface circuitry of claim 13 wherein the media-access control layer circuitry calculates the short-term motion indicator by:
inserting the average RSSI into a first cyclic array that includes the accumulated number of previously generated average RSSIs; and
calculating an average value stored in the first cyclic array,
wherein the short-term motion indicator is calculated based on a gradient using the average value of the first cyclic array and the averaged RSSIs stored in the first cyclic array, and
wherein a predetermined number of the short-term motion indicators are accumulated by the media-access control layer circuitry and the long-term motion indicator is calculated by the media-access control layer circuitry based on an average of the accumulated predetermined number of the short-term motion indicators.

16. A wireless device comprising network interface circuitry and a substantially omnidirectional antenna coupled to the network interface circuitry,
wherein the network interface circuitry comprises:
a physical layer circuitry to measure signal levels received from a currently associated access point over a predetermined period of time; and
a media-access control layer circuitry to refrain from performing periodic scanning when a rate-of-change of the received signal levels indicates little or no movement, or indicates movement in a direction toward the currently associated access point.

17. The wireless device of claim 16 wherein the physical layer circuitry determines received signal strength indicators (RSSIs) of beacon frames regularly transmitted by the currently associated access point.

18. The wireless device of claim 17 wherein the media-access control layer circuitry accumulates and averages the RSSIs over the predetermined period of time to generate an average RSSI, calculates a short-term motion indicator based on the rate-of-change of an accumulated number of the average RSSIs, and calculates a long-term motion indicator based on an average of an accumulated number of the short-term motion indicators, and
wherein the media-access control layer circuitry refrains from periodic scanning when neither the long-term motion indicator nor the short-term motion indicator indicates motion in a direction away from the currently associated access point.

19. The wireless device of claim 18 wherein when the short-term motion indicator is less than or equal to a low threshold value, the short-term motion indicator indicates motion in a direction away from the currently associated access point,
wherein when the short-term motion indicator is greater than or equal to a high threshold value, the short-term motion indicator indicates motion in a direction toward the currently associated access point,
wherein when the short-term motion indicator has a value between the high and low threshold values, the short-term motion indicator indicates little or no motion, and
wherein when the long-term motion indicator is negative, the long-term motion indicator indicates motion in a direction away from the currently associated access point.

20. The wireless device of claim 18 wherein the media-access control layer circuitry calculates the short-term motion indicator by:
inserting the average RSSI into a first cyclic array that includes the accumulated number of previously generated average RSSIs; and
calculating an average value stored in the first cyclic array,
wherein the short-term motion indicator is calculated based on a gradient using the average value of the first cyclic array and the averaged RSSIs stored in the first cyclic array, and
wherein a predetermined number of the short-term motion indicators are accumulated by the media-access control layer circuitry and the long-term motion indicator is calculated by the media-access control layer circuitry based on an average of the accumulated predetermined number of the short-term motion indicators.
